(19) United States
(12) Patent Application Publication
(10) Pub. No.: US 2024/0219909 A1
(43) Pub. Date: Jul. 4, 2024

(54) Route generation device for autonomous mobile body and route generation method for autonomous mobile body

(71) Applicant: HONDA MOTOR CO., LTD., Tokyo (JP)

(72) Inventors: Andrii PYDIN, Saitama (JP); Wei SONG, Saitama (JP)

(21) Appl. No.: 18/148,385

(22) Filed: Dec. 29, 2022

(51) Int. Cl. G05D 1/02

(52) U.S. Cl. CPC G05D 1/0225; G05D 1/0217

(57) ABSTRACT

Provided are a route generation device and a route generation method for an autonomous mobile body that are capable of generating an appropriate route in consideration of waiting time at a destination. A route generation device for an autonomous mobile body to arrive at a plurality of destinations within periods set for the plurality of destinations on a one-to-one basis, the route generation device configured to generate a route going via a waiting place in a case in which the autonomous mobile body is to arrive at the destinations before the periods set if traveling to the plurality of destinations via a shortest route and in which the autonomous mobile body is able to arrive at the destinations within the periods set even if going via the waiting place where maintenance of the autonomous mobile body or predetermined work can be performed; and output the route to a travel control device for the autonomous mobile body so that the autonomous mobile body travels on the route.

### BACKGROUND OF THE INVENTION

### Field of the Invention

The present invention relates to a route generation device for an autonomous mobile body and a route generation method for an autonomous mobile body.

### Related Art

A movement route generation device for an autonomous mobile robot is known. Japanese Patent No. 4282662 discloses a movement route generation device that calculates such a route that causes a robot to travel from a current position to a destination by a shortest distance.
Patent Document 1: Japanese Patent No. 4282662

### SUMMARY OF THE INVENTION

There may be a case where, from the viewpoint of cooperation with other robots and workers, allowable arrival time when an autonomous mobile robot arrives at a destination is decided in advance. In such a case, if going to the destination via the shortest route, the autonomous mobile robot may arrive at the destination earlier than the allowable arrival time. The autonomous mobile robot cannot enter the destination until the allowable arrival time comes. The autonomous mobile robot has to wait in the middle of the route to the destination. Further, if the autonomous mobile robot is carrying a package, the package may be damaged or deteriorated, being affected by the weather while the autonomous mobile robot is waiting.

Therefore, an object of the present invention is to provide a route generation device for an autonomous mobile body and a route generation method for the autonomous mobile body capable of generating an appropriate route in consideration of waiting time at a destination.

(1) An aspect of the present invention is directed to a route generation device for an autonomous mobile body to arrive at a plurality of destinations within periods set for the plurality of destinations on a one-to-one basis. The route generation device is configured to: generate a route going via a waiting place in a case in which the autonomous mobile body is to arrive at the destinations before the periods set if traveling to the plurality of destinations via a shortest route and in which the autonomous mobile body is able to arrive at the destinations within the periods set even if going via the waiting place where maintenance of the autonomous mobile body or predetermined work can be performed; and output the route to a travel control device for the autonomous mobile body so that the autonomous mobile body travels on the route.

(5) Another aspect of the present invention is directed to a route generation method for an autonomous mobile body to arrive at a plurality of destinations within periods set for the plurality of destinations on a one-to-one basis. The method includes: a node registration step of registering positions of nodes; a work registration step of registering content of work at the nodes; a route generation step of generating a route for the autonomous mobile body based on the positions of the nodes and the content of the work that have been registered; a passability judgment step of judging whether it is possible for the route to go via a waiting place or not; and a waiting route creation step of, in a case in which the route has been judged to be able to go via the waiting place in the passability judgment step, creating a waiting route going via the waiting place.

According to the route generation device for the autonomous mobile body according to (1) and the route generation method for an autonomous mobile body according to (5), while delivery within a predetermined time is enabled, it is possible to, by going via a waiting place where maintenance work can be performed, for example, a loading place, prevent a package from being exposed to sunshine or rain in comparison with the case of waiting outdoors if the waiting place is provided with a roof, and it is possible to perform loading of a package again utilizing waiting time, and, in some cases, maintenance such as charging if the waiting place is a loading place.

(2) The route generation device for the autonomous mobile body according to (1) generates the route going via the waiting place in a case in which the autonomous mobile body is to arrive at the destinations earlier than the periods set by a predetermined time or more if traveling to the plurality of destinations via the shortest route.

According to the route generation device for the autonomous mobile body according to (2), it is possible to simply calculate a judgment about whether or not to go via a waiting place.

(3) The route generation device for the autonomous mobile body according to (1) or (2) generates the route going via the waiting place in a case in which the autonomous mobile body is able to arrive at the destinations within the predetermined periods even if waiting at the waiting place for a predetermined time or more.

According to the route generation device for the autonomous mobile body according to (3), it is possible to secure time for performing additional work, for example, maintenance at a waiting place.

(4) In a case in which there are a plurality of the waiting places, the route generation device for the autonomous mobile body according to any one of (1) to (3) generates a route going via one of the waiting places that is at a shortest distance from a predetermined point.

According to the route generation device for the autonomous mobile body according to (4), it is possible to reduce power consumption and movement time.

The present invention provides a route generation device and a route generation method for an autonomous mobile body that are capable of generating an appropriate route in consideration of waiting time at a destination.

### BRIEF DESCRIPTION OF THE DRAWINGS

FIG. 1 is a diagram showing a schematic configuration of an autonomous mobile body;

FIG. 2 is a functional block diagram of a control apparatus;

FIG. 3 is a diagram showing arrangement of nodes;

FIG. 4 is a diagram showing a model of arrangement of nodes for explaining a judgment formula;

FIG. 5 is a diagram showing the judgment formula;

FIG. 6 is a diagram showing a conventional route;

FIG. 7 is a diagram showing a route according to the present embodiment;

FIG. 8 is another diagram showing the conventional route;

FIG. 9 is a diagram showing another route according to the present embodiment; and

FIG. 10 is a flowchart showing a flow of a process of a route generation method.

### DETAILED DESCRIPTION OF THE INVENTION

An embodiment for practicing the invention will be described with reference to drawings. As an example of an autonomous mobile body 1 of the present embodiment, an autonomous carriage for carrying a package is given. In the description of a route generation device for the autonomous mobile body 1 below, a case where the autonomous mobile body 1 is an autonomous carriage will be described as an example. The autonomous carriage is also referred to as an AWV (autonomous work vehicle).

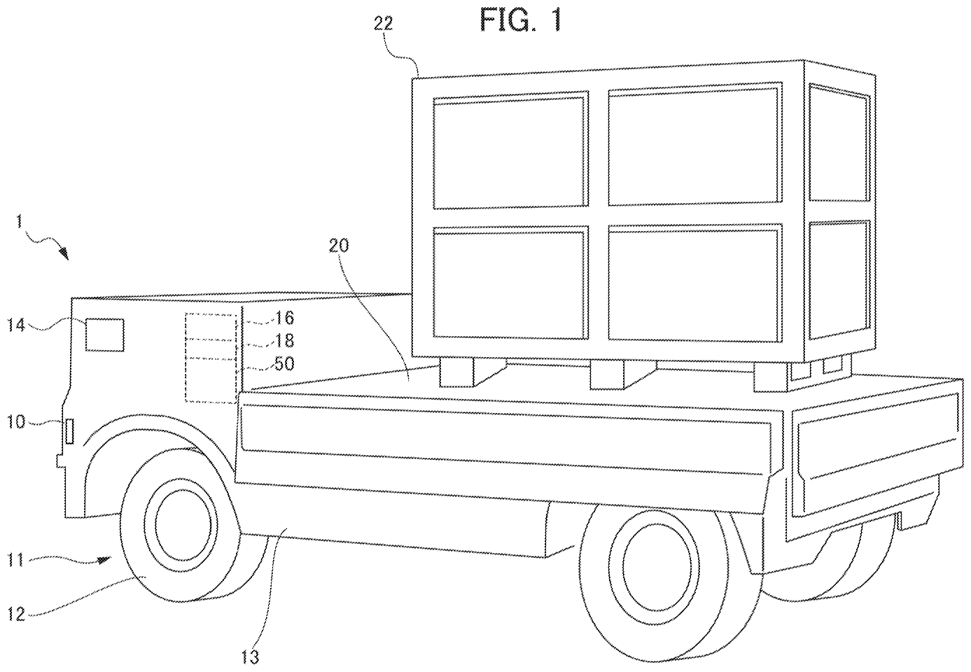

FIG. 1 is a diagram showing a schematic configuration of the autonomous mobile body 1. The autonomous mobile body 1 includes a vehicle body 10 and a traveling unit 11.

The vehicle body 10 includes a loading platform 20, a control apparatus 50, an input unit 14, a communication apparatus 16 and a GPS apparatus 18. The loading platform 20 is a place where a package 22 is put. The input unit 14 is a unit to accept an input to the control apparatus 50. The input unit 14 is electrically connected to the control apparatus 50. As an example of the input unit 14, a touch panel is given.

The communication apparatus 16 is an apparatus to perform transmission/reception of information between the autonomous mobile body 1 and the outside. The communication apparatus 16 is electrically connected to the control apparatus 50. The information the communication apparatus 16 transmits and receives includes allowable arrival time of arriving at each of points such as nodes, content of work performed at each point, time to start the work, time required for the work, and the like. As examples of the work, loading, unloading, reloading of a package are given.

The traveling unit 11 includes wheels 12 and a drive unit 13. The wheels 12 are rotatably supported on the front left and right and on the rear left and right of the autonomous mobile body 1, respectively. The drive unit 13 is a unit to drive the wheels 12. As an example of the drive unit 13, a motor is given.

The traveling unit 11 has a function of causing the autonomous mobile body 1 to travel. The traveling unit 11 causes the autonomous mobile body 1 to travel based on a route generated by a route generation device 512.

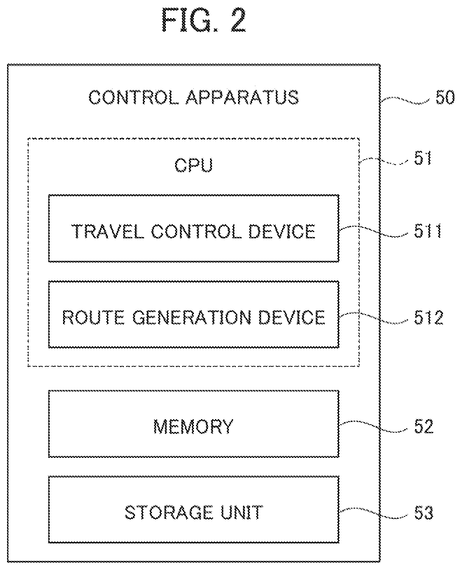

FIG. 2 is a functional block diagram of the control apparatus 50. As an example of the control apparatus 50, an ECU (electronic control unit) is given. Functions of the control apparatus 50 may be realized by a semiconductor integrated circuit. As examples of the semiconductor integrated circuit, a PLD (programmable logic device) and an ASIC (application specific integrated circuit) are given. The functions of the control apparatus 50 may be realized by software. The functions of the control apparatus 50 can be realized by either hardware or software.

The control apparatus 50 includes a CPU (central processing unit) 51, a memory 52 and a storage unit 53. The CPU 51 develops a program stored in the storage unit 53 on the memory 52 and executes the program. The CPU 51 controls each unit of the autonomous mobile body 1 based on the developed program.

The CPU 51 functions as a travel control device 511 and the route generation device 512.

The CPU 51 functions as the travel control device 511. The CPU 51 controls the traveling unit 11. The traveling unit 11 causes the autonomous mobile body 1 to travel based on a route generated by the route generation device 512. The traveling unit 11 causes the autonomous mobile body 1 to autonomously travel by control from the traveling unit 11. Autonomous travel means to travel without a driver on board. The autonomous mobile body 1 carries a package from one point to another point by autonomously traveling.

The CPU 51 functions as the route generation device 512. The CPU 51 generates a route on which the autonomous mobile body 1 travels, based on position information about nodes and the like.

The storage unit 53 is a unit to store various kinds of information. The information includes information about routes and information about a route generated by the route generation device 512. The information about routes includes the position information about the nodes, and travel speed between nodes.

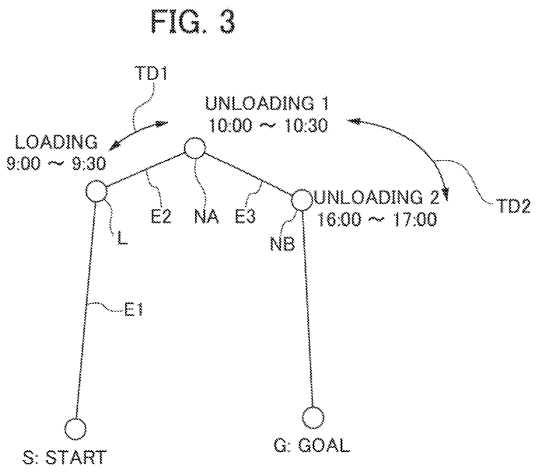

General carriage of a package by the autonomous mobile body 1 will be described. FIG. 3 is a diagram showing an overview of carriage of a package. The diagram shown in FIG. 3 is also referred to as a route map. A carriage route may be referred to as a route. The autonomous mobile body 1 moves from a start S to a goal G. Between the start S and the goal G, there are one loading place L and two nodes. The two nodes are an unloading place 1 and an unloading place 2. The loading place and the unloading places are referred to as work places.

The loading place L is a place where loading of a package onto the autonomous mobile body 1 is performed.

The unloading places 1 and 2 are places where unloading from the autonomous mobile body 1 is performed. The unloading place 1 is referred to as a node A. The unloading place 2 is referred to as a node B.

“Node” is indicated by “N”. The unloading place 1 is indicated by an unloading place 1NA. The unloading place 2 is indicated by an unloading place 2NB.

A period in which work is allowed is referred to as a workable period. Workable periods for the loading place L, the unloading place 1NA, and the unloading place 2NB are specified in advance. Work at these places includes loading and unloading of a package.

The workable period at the loading place L is from 9:00 to 9:30. The workable period at the unloading place 1NA is from 10:00 to 10:30. The workable period at the unloading place 2NB is from 16:00 to 17:00.

A section from the start S to the loading place L is referred to as a first edge E1. A section from the loading place L to the unloading place 1NA is referred to as a second edge E2. A section from the unloading place 1NA to the unloading place 2NB is referred to as a third edge E1.

The autonomous mobile body 1 starts movement at the start S. The autonomous mobile body 1 leaves the start S at such time that loading of a package at the loading place L is performed between 9:00 and 9:30. The control apparatus 50 decides time for the autonomous mobile body 1 to leave the start S, based on the distance of the edge E1, movement speed on the edge E1, and the like.

After finishing loading at the loading place L, the autonomous mobile body 1 leaves the loading place L for the unloading place 1NA. After the loading place L, the autonomous mobile body 1 similarly moves to the next node after finishing work at each node. The autonomous mobile body 1 goes to the goal G after finishing all the work.

Time difference between workable periods at work places depends on nodes. The time difference between the workable periods at the loading place L and the unloading place 1NA is indicated by a time difference TD1. The maximum time difference TD1 is 1 hour and 30 minutes, and the minimum time difference TD1 is 0 hour and 30 minutes.

The time difference between the workable periods at the unloading place 1NA and the unloading place 2NB is indicated by a time difference TD2. The maximum time difference TD2 is 7 hours and 0 minute, and the minimum time difference TD2 is 5 hours and 30 minutes.

When the time difference between workable periods at work places is large, the autonomous mobile body 1 has to wait at a work place or on an edge.

The time difference between workable periods will be described, with movement from the unloading place 1NA to the unloading place 2NB taken as an example. It is assumed that the autonomous mobile body 1 can move on the edge E3 in 1 h. It is assumed that the autonomous mobile body 1 finishes unloading at the unloading place 1NA at 10:30. The autonomous mobile body 1 leaves the unloading place 1NA at 10:30 and arrives at the unloading place 2NB at 11:30. The autonomous mobile body 1 has to wait for 4 hours and 30 minutes until it becomes possible to perform work at the unloading place 2NB.

It is necessary for the autonomous mobile body 1 to delay the time of departure from the unloading place 1NA and wait at the unloading place 1NA, or wait at the unloading place 2NB.

At each work place, in a period other than a period in which one autonomous mobile body 1 can perform work, another autonomous mobile body 1 may be performing work. If another autonomous mobile body 1 is performing work, the autonomous mobile body 1 cannot stay at the work place in periods other than the workable period set for the autonomous mobile body 1 itself. If it is not possible to stay at the work place, the autonomous mobile body 1 has to wait on an edge.

This will be described, with a case of moving from the unloading place 1NA to the unloading place 2NB taken as an example. At the unloading place 2NB, any other work may be performed until 16:00 at which it becomes possible for the autonomous mobile body 1 to perform work. If any other work is being performed at the unloading place 2NB, the autonomous mobile body 1 has to wait on the edge E3.

An unloading place or a place on an edge may be an open place without anything where a roof and the like are not provided. It may cause deterioration of a package and promote deterioration of the vehicle body that the autonomous mobile body 1 stays on an unloading place or a place on an edge for a long time.

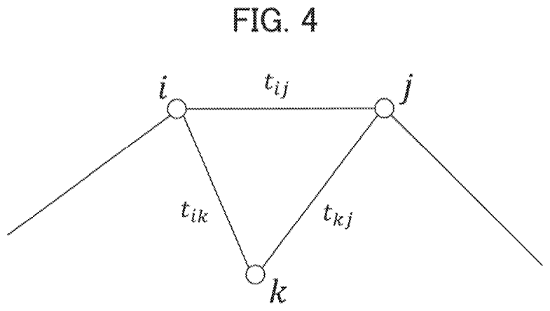

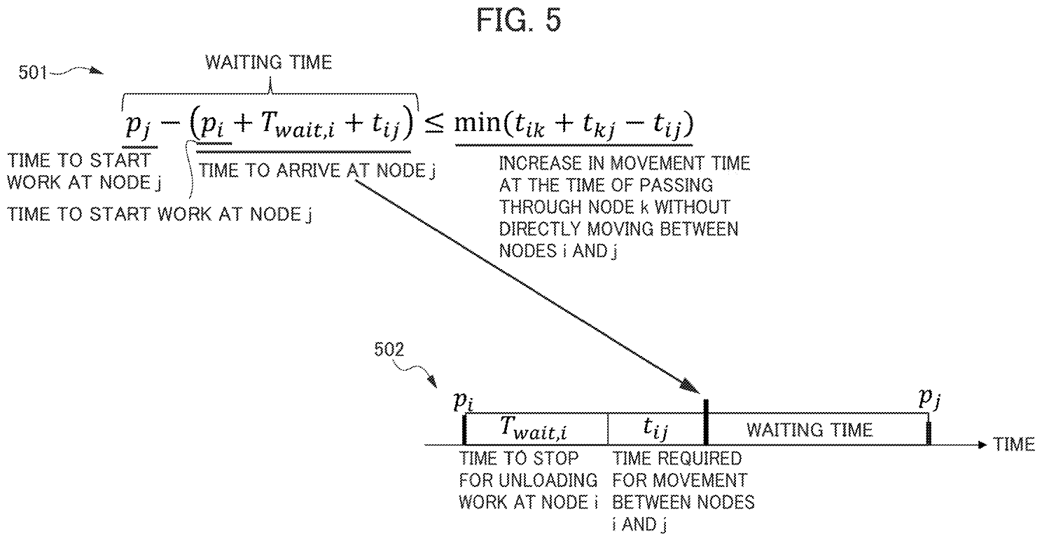

In a route generation of the present embodiment, it is prevented that the autonomous mobile body 1 stays under an unfavorable situation for a long time, by using a judgment formula. As an example of the unfavorable situation, being exposed is given. FIG. 4 is a diagram showing a model of arrangement of nodes. The model of FIG. 4 is a model for explaining the judgment formula. FIG. 5 is a diagram showing the judgment formula.

The idea of the judgment formula is as follows. For two consecutive unloading places, if waiting time at the second unloading place is equal to or less than an increase in movement time corresponding to time required to return to the loading place L once and go to the second unloading place, the autonomous mobile body 1 waits at the second unloading place. It is assumed that the case where the waiting time is equal to or less than the increase in the movement time is a case where the judgment formula is satisfied.

For two consecutive unloading places, if waiting time at the second unloading place exceeds an increase in movement time corresponding to time required to return to the loading place L once and go to the second unloading place, the autonomous mobile body 1 returns to the loading place L. The loading place L is an example of the waiting place. It is assumed that the case where the waiting time exceeds the increase in the movement time is a case where the judgment formula is not satisfied.

The loading place L is generally provided with a roof. The loading place L may be air-conditioned. The reason for the loading place L being provided with a roof is that, on the loading place L, a package waiting to be loaded is generally placed.

By the autonomous mobile body 1 returning to the loading place L and waiting, deterioration of a package and deterioration of the vehicle can be prevented.

In FIG. 4, i, j, and k indicate the first unloading place, the second unloading place, and a waiting place, respectively. As an example of the waiting place, a loading place is given. The waiting place is not limited to a loading place. The waiting place is any place that can prevent deterioration of a package and deterioration of the vehicle.

In FIG. 4, tᵢⱼ, tᵢₖ, and tₖⱼ indicate movement time between i and j, movement time between i and k, and movement time between k and j, respectively.

In FIG. 5, reference numeral 501 indicates the judgment formula. The left side of the judgment formula indicates waiting time. The waiting time is waiting time at the node j in the case of the autonomous mobile body 1 directly reaching the node j from the node i without going via the waiting place k. The right side of the judgment formula indicates an increase in movement time in the case of going via the waiting time k. If the value of the left side exceeds the value of the right side, the autonomous mobile body 1 can arrive at the node j within the workable period even if going via the waiting place k.

In the route generation device 512 and a route generation method of the present embodiment, a route is created using the judgment formula indicated by 501 in FIG. 5. The created route goes via the waiting place k if it is judged by a judgment using the judgment formula that it is possible to go via the waiting place k.

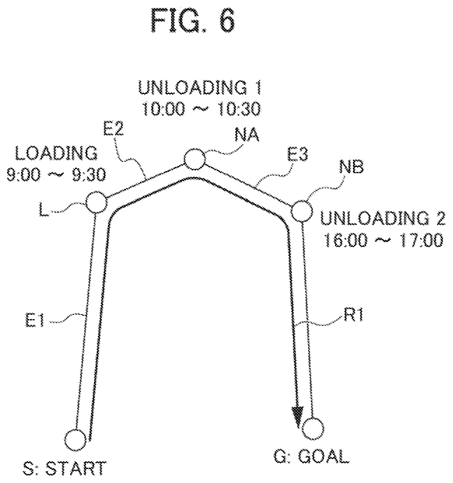

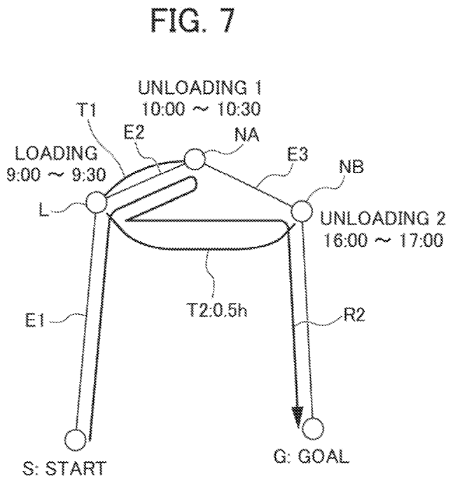

A specific example of going via a waiting place will be described based on FIGS. 6 and 7. FIG. 6 is a diagram showing a conventional route R1. FIG. 7 is a diagram showing a route R2 according to the present embodiment.

The conventional route R1 shown in FIG. 6 is such a route that the autonomous mobile body 1 goes via the loading place L, the unloading place 1NA, and the unloading place 2NB in that order. In the case of the route R1, the autonomous mobile body 1 has to wait at the unloading place 1NA, at the unloading place 2NB, or on the edge E3.

The route R2 according to the present embodiment shown in FIG. 7 is such a route that the autonomous mobile body 1 returns to the loading place L from the unloading place 1NA and then moves from the loading place L to the unloading place 2NB. According to the route R2, the autonomous mobile body 1 can wait at the loading place L. The autonomous mobile body 1 does not have to wait at the unloading place 1NA, at the unloading place 2NB, or on the edge E3. The route R2 can prevent deterioration of a package and deterioration of the vehicle.

The route R2 will be specifically described. In FIG. 7, T1 indicates movement time from the loading place L to the unloading place 1NA. T2 indicates movement time in the case of directly moving from the loading place L to the unloading place 2NB. The direct movement means going not via the unloading place 1NA. The movement time T1 is 0.5 hours.

If the movement time T1 is short, it is possible to return to the loading place L from the unloading place 1NA. The reason is that the value of the left side of the judgment formula exceeds the value of the right side. It is assumed that the movement time T1 is 0.5 hours. The autonomous mobile body 1 that leaves the unloading place 1NA at 10:30 arrives at the loading place L at 11:00. Movement time from the unloading place 1NA to the unloading place 2NB is 0.5 hours. The workable period at the unloading place 2NB starts at 16:00. The autonomous mobile body 1 can wait for 4 hours and 30 minutes at the loading place L. Even after waiting for 4 hours 30 minutes, the autonomous mobile body 1 can arrive at the unloading place 2NB within the workable period.

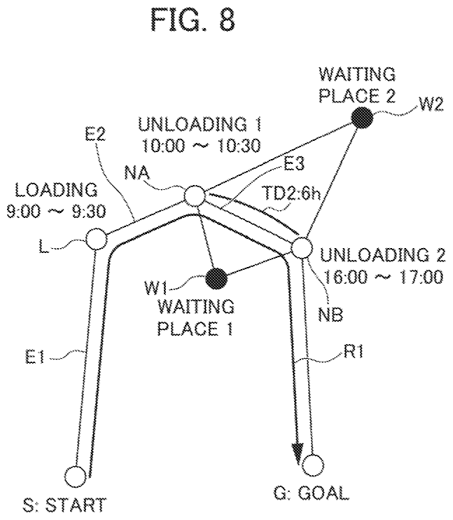

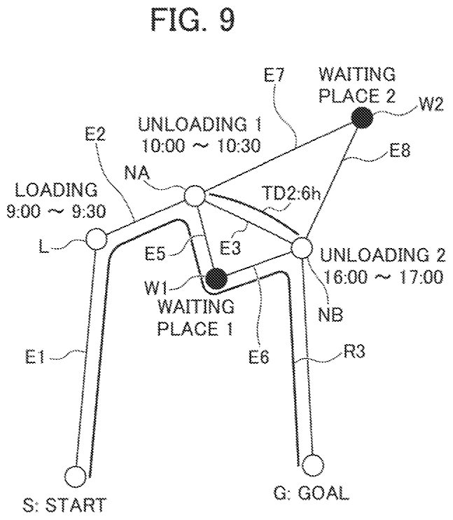

Generation of a route in a case where there are a plurality of waiting places will be described based on FIGS. 8 and 9. FIG. 8 is a diagram showing the conventional route R1. FIG. 9 is a diagram showing another route R3 according to the present embodiment. Arrangement of nodes and the like shown in FIGS. 8 and 9 and the arrangement of nodes and the like shown in FIGS. 6 and 7 are different in whether waiting places are set or not. The waiting places here mean waiting places different from the loading place L. In the arrangement shown in FIGS. 6 and 7, no waiting place is set. In the arrangement shown in FIGS. 8 and 9, waiting places are set.

In the arrangement of nodes shown in FIGS. 8 and 9, two waiting places are set. The two waiting places are a waiting place 1W1 and a waiting place 2W2. It is assumed that the waiting places are provided with roofs. At the waiting places, deterioration of a package and deterioration of the vehicle are prevented.

The conventional route R1 shown in FIG. 8 goes via neither the waiting place 1W1 nor the waiting place 2W2. The route R1 arrives at the goal G from the start S, going via the loading place L, the unloading place 1NA, and the unloading place 2NB in that order. In the case of moving with the route R1, the autonomous mobile body 1 has to wait at the unloading place 1NA, at the unloading place 2NB, or on the edge E3. The reason why the autonomous mobile body 1 has to wait is that the time difference TD2 between the workable periods at the unloading place 1NA and the unloading place 2NB is long.

In the case of the route R3 shown in FIG. 9, the autonomous mobile body 1 goes to the unloading place 2NB via the waiting place 1W1 after leaving the unloading place 1NA. The autonomous mobile body 1 waits at the waiting place 1W1. The autonomous mobile body 1 leaves the waiting place 1W1 so as to arrive at the unloading place 2NB within the workable period.

In the arrangement of nodes shown in FIG. 9, there are three candidates for a waiting place to move to after finishing unloading at the unloading place 1NA. The three candidates are the loading place L, the waiting place 1W1, and the waiting place 2W2. The route can go via any waiting place if it is judged by the judgment formula that it is possible to go via the waiting place.

A favorable route is a route going via a waiting place with a short movement distance. The reason why such a route is favorable is that movement costs can be reduced.

In the arrangement of nodes shown in FIG. 9, a route going via the waiting place 1W1 includes movement on an edge E5 and movement on an edge E6. A route going via the waiting place 2W2 includes movement on an edge E7 and movement on an edge E8. The sum of the distances of the edges E5 and E6 is shorter than the sum of the distances of the edges E7 and E8. In the case of the route R3, the waiting place 1W1 is selected as a waiting place. The reason for the selection is that the movement distance is short.

A place where the autonomous mobile body 1 waits is not limited to the loading place L. A place other than the loading place L may be separately provided as the place where the autonomous mobile body 1 waits, as shown in FIG. 9. The number of waiting places is not limited to one. There may be a plurality of waiting places.

When there are a plurality of waiting places, the waiting place selection criterion is not limited to distance. Any waiting place selection criterion, such as movement time, movement route environment, waiting place facilities, or autonomous mobile body conditions, can be arbitrarily set.

In the case of desiring to lengthen waiting time at a waiting place, movement time can be set as the selection criterion. As examples of the reason for desiring to lengthen the waiting time, performing loading of a package again, performing reloading of a package, performing maintenance for the autonomous mobile body 1, supplying fuel to the autonomous mobile body 1, and charging the autonomous mobile body 1 at the waiting place are given.

In the case of preventing deterioration of a package and deterioration of the vehicle, movement route environment can be set as the selection criterion. As an example of setting the movement route environment as the selection criterion, it is exemplified that, in the case of a package that is prone to deterioration, a movement route with a long distance but with a low temperature and a low humidity is more favorable than a movement route with a short distance but with a high temperature and a high humidity. As another example of setting the movement route environment as the selection criterion, it is exemplified that, in the case of desiring to prevent the temperature of the vehicle battery from being high, a movement route with a long distance but without exposition to direct sunlight is more favorable than a movement route with a short distance but with exposition to direct sunlight.

In the case where work such as reloading of a package, maintenance of the autonomous mobile body 1, supply of fuel to the autonomous mobile body 1, or charging the autonomous mobile body 1 is required, waiting place facilities can be set as the selection criterion. The reason for setting the waiting place facilities as the selection criterion is that a waiting place to go via is required to be provided with facilities required for each work.

In a case where the autonomous mobile body 1 has little fuel, the battery of the autonomous mobile body 1 is low, or the autonomous mobile body 1 is not in good condition, the autonomous mobile body conditions can be set as the selection criterion. This is because, depending on the conditions of the autonomous mobile body 1, it may be favorable to select a waiting place by complexly considering various items, such as the position of the waiting place, conditions of a route to the waiting place, speed at the time of moving to the waiting place, and fuel consumption at the time of moving to the waiting place.

The selection of a waiting place may be decided by a user. The route generation device 512 presents a plurality of kinds of routes to the user. Waiting places via which the routes go may be different. Presentation of the routes to the user and selection of a route by the user may be performed via the input unit 14.

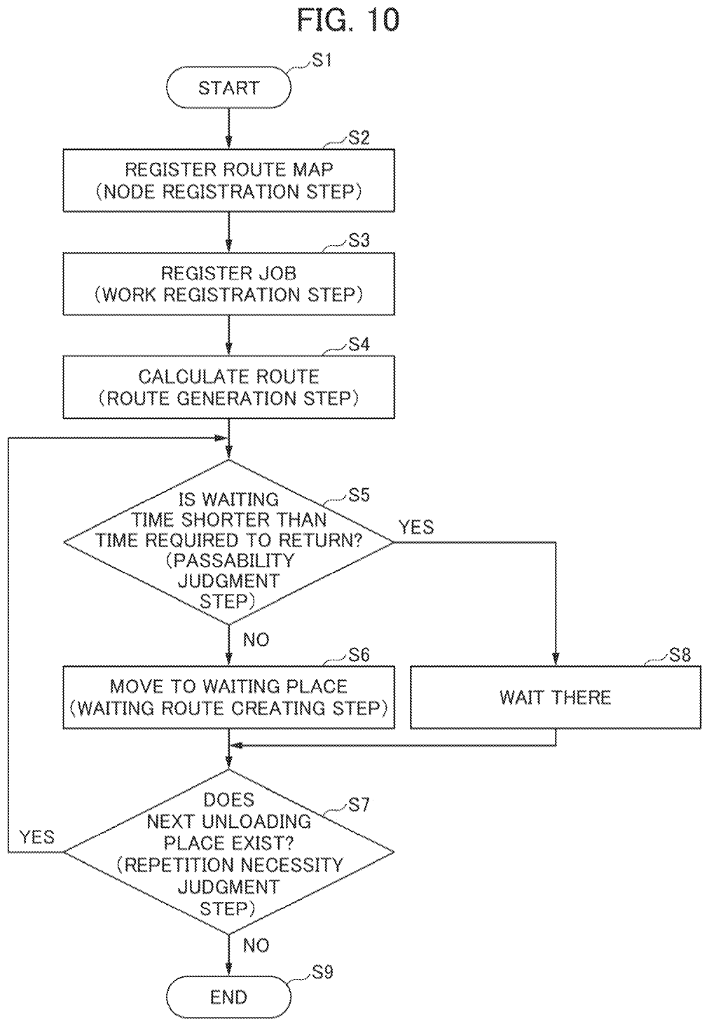

A flow of a process of the route generation method will be described based on FIG. 10. FIG. 10 is a flowchart showing the flow of the process of the route generation method of the present embodiment. Here, S in S1 means step. The same goes for other steps.

S1 is a start step. The start step is a step at which the process of the route generation method starts.

S2 is a node registration step. The node registration step is a step at which a route map is registered with the storage unit 53. Registered data is data of positions of points. As an example of the data of the positions, latitudes and longitudes of the points are given. The points include the start S, the goal G, the loading place L, unloading places, waiting places, and the like. The route map can be obtained by plotting the points.

Registered data can include facilities at the points, environments at the points, movement speeds between points, environments between points, and the like.

S3 is a work registration step. The work registration step is a step at which a job is registered with the storage unit 53. As examples of registered data, data about a package, data about content of work, and data about time are given.

The data about a package can include the kind of the package, the size of the package, the weight of the package, notes about the package, and the like. The data about content of work can include how and at which point, which and how many packages are to be loaded or unloaded, and the like. The data about time can include time assumed to be required for each work, a workable period at each point, time during which the autonomous mobile body 1 can stay at each point, and the like.

The data registration at S2 and S3 can be performed from the input unit 14 of the autonomous mobile body 1.

S4 is a route generation step. The route generation step is a step at which the route generation device 512 calculates a route. The calculation of a route is performed based on the data registered at S1 and S2. At the time of calculating a route, the route generation device 512 reads out necessary data from the storage unit 53. The route generated by the calculation is communicated to the travel control device 511. The travel control device 511 controls the traveling unit 11 based on the communicated route.

S5 is a passability judgment step. The passability judgment step is a step at which the route generation device 512 judges whether or not to move to a waiting place, using the judgment formula. It is judged whether or not waiting time at the next unloading place or the like is equal to or less than movement time that is additionally required by moving to the waiting place such as returning to a loading place. The movement time that is additionally required by moving to the waiting place is referred to as increased time. If a result of the judgment is Yes, the process proceeds to S8. If the result of the judgment is No, the process proceeds to S6.

S6 is a waiting route creation step. The waiting route creation step is a step at which the route generation device 512 creates a waiting route. The waiting route is such a route that the autonomous mobile body 1 moves to the waiting place and goes to the next node from the waiting place.

Since the waiting time is not equal to or less than the increased time, the autonomous mobile body 1 can move to the waiting place. The route generation device 512 creates a route for the autonomous mobile body 1 to move to the waiting place and then go to the next node from the waiting place. The travel control device 511 controls the traveling unit 11 based on the waiting route communicated from the route generation device 512. By the traveling unit 11 operating based on the waiting route, the autonomous mobile body 1 moves to the waiting place.

S8 is a step at which the autonomous mobile body 1 waits at an unloading place or the like without moving to the waiting place. Since the waiting time is equal to or less than the increased time, the autonomous mobile body 1 cannot move to the waiting place.

S7 is a repetition necessity judgment step. The repetition necessity judgment step is a step at which the route generation device 512 judges whether the next unloading place exists or not. If the next unloading place exists, the process returns to S5. The process at and after S5 is repeated again. If the next unloading place does not exist, the process proceeds to S9.

S9 is an end step. The end step is a step at which the process of the route generation method ends.

An embodiment of the present invention has been described above. The present invention, however, is not limited to the embodiment described above, and various changes, modifications and combinations are possible.

The creation of a waiting route by the route generation device 512 can be performed in the case of, by traveling to a plurality of destinations with the shortest route, arriving at points to be the destinations earlier than set periods by a predetermined time or more. The predetermined time can be set, for example, to be 1 hour. Thereby, it is possible to simply calculate a judgment about whether or not to go via a waiting place such as a loading place.

The creation of a waiting route by the route generation device 512 can be performed when, even in the case of waiting at a waiting place for a predetermined time or more, it is possible to arrive at a point as a destination within a predetermined period. Thereby, it is possible to secure time for performing additional work such as maintenance of the vehicle at a waiting place.

What the autonomous mobile body 1 carries is not limited to a package. The autonomous mobile body 1 may carry what is other than a package, such as a person.

### EXPLANATION OF REFERENCE NUMERALS

1: Autonomous mobile body
10: Vehicle body
11: Traveling unit
12: Wheel
13: Drive unit
14: Input unit
16: Communication apparatus
18: GPS apparatus
20: Loading platform
22: Package
50: Control apparatus
51: CPU
511: Travel control device
512: Route generation device
52: Memory
53: Storage unit

What is claimed is:

1. A route generation device for an autonomous mobile body to arrive at a plurality of destinations within periods set for the plurality of destinations on a one-to-one basis, the route generation device configured to:
generate a route going via a waiting place in a case in which the autonomous mobile body is to arrive at the destinations before the periods set if traveling to the plurality of destinations via a shortest route, and in which the autonomous mobile body is able to arrive at the destinations within the periods set even if going via the waiting place where maintenance of the autonomous mobile body or predetermined work can be performed; and
output the route to a travel control device for the autonomous mobile body so that the autonomous mobile body travels on the route.

2. The route generation device for the autonomous mobile body according to claim 1, wherein
the route generation device generates the route going via the waiting place in a case in which the autonomous mobile body is to arrive at the destinations earlier than the periods set by a predetermined time or more if traveling to the plurality of destinations via the shortest route.

3. The route generation device for the autonomous mobile body according to claim 1, wherein
the route generation device generates the route going via the waiting place in a case in which the autonomous mobile body is able to arrive at the destinations within the predetermined periods even if waiting at the waiting place for a predetermined time or more.

4. The route generation device for the autonomous mobile body according to claim 1, wherein
in a case in which there are a plurality of the waiting places, the route generation device generates a route going via one of the waiting places that is at a shortest distance from a predetermined point.

5. A route generation method for an autonomous mobile body to arrive at a plurality of destinations within periods set for the plurality of destinations on a one-to-one basis, the method comprising:
a node registration step of registering positions of nodes;
a work registration step of registering content of work at the nodes;
a route generation step of generating a route for the autonomous mobile body based on the positions of the nodes and the content of the work that have been registered;
a passability judgment step of judging whether it is possible for the route to go via a waiting place or not; and
a waiting route creation step of, in a case in which the route has been judged to be able to go via the waiting place in the passability judgment step, creating a waiting route going via the waiting place.
